(19) United States
(12) Patent Application Publication
(10) Pub. No.: US 2012/0242722 A1
(43) Pub. Date: Sep. 27, 2012

(54) DISPLAY PANEL DRIVE DEVICE, SEMICONDUCTOR INTEGRATED DEVICE, AND IMAGE DATA ACQUISITION METHOD IN DISPLAY PANEL DRIVE DEVICE

(76) Inventors: Hiroaki ISHII, Ibaraki (JP); Atsushi HIRAMA, Tokyo (JP)

(21) Appl. No.: 13/369,540

(22) Filed: Feb. 9, 2012

(30) Foreign Application Priority Data
Mar. 24, 2011 (JP) 2011-065241

(51) Int. Cl. G09G 5/10; G09G 5/00

(52) U.S. Cl. 345/691; 345/213

(57) ABSTRACT

A display panel drive device for applying a drive pulse to data lines of a display panel according to a video signal includes a latch portion and an output amplifier. The latch portion includes a first latch section, a delay circuit, and a second latch section. The first latch section is provided for capturing the pixel data pieces or retaining the pixel data pieces. The delay circuit is provided for generating a delayed load clock signal. The second latch section is provided for capturing the pixel data pieces or retaining the pixel data pieces. The delayed load clock signal is transited to the first level state after a first delay time, and the delayed load clock signal is transited to the second level state after a second delay time shorter than the first delay time.

### BACKGROUND OF THE INVENTION AND RELATED ART STATEMENT

The present invention relates to a display panel drive device for driving a display panel. In particular, the present invention relates to a display panel drive device for applying a drive pulse to each of data lines of a display panel according to an input video signal. Further, the present invention relates to a semiconductor integrated device in which the display panel drive device is disposed, and an image data acquisition method in the display panel drive device.

In a display panel of a flat plane type such as a liquid crystal display panel, scanning lines in the number of n (n is an integer greater than two) are arranged to extend in a horizontal direction of a two-dimensional screen. Further, signal lines in the number of m (m is an integer greater than two) are arranged to extend in a vertical direction of the two-dimensional screen. Further, the signal lines are arranged such that the signal lines cross the scanning lines. Electrodes corresponding to pixels are disposed at crossing points between the signal lines and the scanning lines.

Further, the display panel includes a signal driver for applying a voltage corresponding to a brightness level indicated with an input video signal to each of the signal lines. Patent Reference has disclosed a conventional signal driver. The conventional signal driver disclosed in Patent Reference includes a first latch group, a second latch group, a D/A converter, and an output amplifier.
Patent Reference: Japanese Patent Publication No. 2010-39061

In the conventional signal driver disclosed in Patent Reference, the first latch group is provided for correlating the input video signal to each of the signal lines in the number of m, and for sequentially capturing the input video signal formed of a series of display data per pixel. The second latch group is provided for capturing each of the display data in the number of m captured with the first latch group. The D/A converter is provided for separately converting each of data pieces captured with the second latch group to analog drive voltages in the number of m. The output amplifier is provided for applying the analog drive voltages in the number of m supplied from the D/A converter to each of the signal lines.

In the conventional signal driver disclosed in Patent Reference, it is preferred that the output amplifier possesses a high output current performance. When that the output amplifier possesses a high output current performance, it is possible to increase a length of the signal lines associated with an increase in a size and a pixel density of the display panel.

In the conventional signal driver disclosed in Patent Reference, when the output amplifier possesses a high output current performance, a large current tends to instantly flow into the signal lines when a value of each of the display data captured with the second latch group is switched from a low level state to a high level state, or from a high level state to a low level state. When a large current instantly flows into the signal lines, a large noise may be generated.

In the conventional signal driver disclosed in Patent Reference, in order to reduce such a large noise, it is proposed that each of latches constituting the second latch group is configured to capture the display data at a capture timing, and the capture timing is forcibly delayed by various delay amounts. Accordingly, it is possible to spread the capture timings over a specific period of time. As a result, it is possible to reduce an amount of an electric current flowing at the same time, thereby reducing the large noise. It is noted that when the delay amounts increase, it is possible to prolong an interval of the capture timings thus spread, thereby further effectively reducing the large noise.

Recently, the size and the pixel density of the display panel have been increased. With the increase in the size and the pixel density of the display panel, a clock signal with a higher frequency is applied to each of the latches constituting the first latch group and the second latch group in a shorter cycle. Accordingly, when the delay amount is increased to suppress the noise, the capture timing of the latch in the second latch group may be overlapped with the capture timing of the latch in the first latch group for capturing subsequent display data. If the two capture timings are overlapped, the display data may be erroneously captured, thereby causing an erroneous operation.

In view of the problems described above, an object of the present invention is to provide a display panel drive device capable of solving the problems of the conventional display panel drive device. A further object of the present invention is to provide a semiconductor integrated device in which the display panel drive device is disposed, and an image data acquisition method in the display panel drive device. In the present invention, it is possible to reduce the noise associated with the instant flow of the large current without the erroneous operation.

Further objects and advantages of the invention will be apparent from the following description of the invention.

### SUMMARY OF THE INVENTION

In order to attain the objects described above, according to a first aspect of the present invention, a display panel drive device is configured to apply a drive pulse to each of a plurality of data lines formed in a display panel according to a video signal.

According to the first aspect of the present invention, the display panel drive device includes a latch portion and an output amplifier. The latch portion is provided for capturing each of pixel data pieces for one horizontal scan per each pixel at a timing different from each other according to the video signal, and for outputting each of the pixel data pieces as a captured pixel data piece. The output amplifier is provided for applying the drive pulse corresponding to a brightness level indicated with each of the captured pixel data pieces to each of the data lines of the display panel.

According to the first aspect of the present invention, the latch portion includes a first latch section, a delay circuit, and a second latch section. The first latch section is provided for capturing the pixel data pieces when a load clock signal is in a first level state, and for retaining the pixel data pieces captured when the load clock signal is in the first level state when the load clock signal is in a second level state. The delay circuit is provided for generating a delayed load clock signal through delaying the load clock signal. The second latch section is provided for capturing the pixel data pieces when the delayed load clock signal is in a first level state, and for retaining the pixel data pieces captured when the delayed load clock signal is in the first level state when the delayed load clock signal is in a second level state.

According to the first aspect of the present invention, it is configured that the delayed load clock signal is transited to the first level state after a first delay time after the load clock signal is transited from the second level state to the first level state. Further, it is configured that the delayed load clock signal is transited to the second level state after a second delay time after the load clock signal is transited from the first level state to the second level state, and the first delay time is longer than the second delay time.

According to a second aspect of the present invention, a semiconductor integrated device is configured to generate a drive pulse to be applied to each of a plurality of data lines formed in a display panel according to a video signal.

According to the second aspect of the present invention, the display panel drive device includes a latch portion and an output amplifier. The latch portion is provided for capturing each of pixel data pieces for one horizontal scan per each pixel at a timing different from each other according to the video signal, and for outputting each of the pixel data pieces as a captured pixel data piece. The output amplifier is provided for applying the drive pulse corresponding to a brightness level indicated with each of the captured pixel data pieces to each of the data lines of the display panel.

According to the second aspect of the present invention, the latch portion includes a first latch section, a delay circuit, and a second latch section. The first latch section is provided for capturing the pixel data pieces when a load clock signal is in a first level state, and for retaining the pixel data pieces captured when the load clock signal is in the first level state when the load clock signal is in a second level state. The delay circuit is provided for generating a delayed load clock signal through delaying the load clock signal. The second latch section is provided for capturing the pixel data pieces when the delayed load clock signal is in a first level state, and for retaining the pixel data pieces captured when the delayed load clock signal is in the first level state when the delayed load clock signal is in a second level state.

According to the second aspect of the present invention, it is configured that the delayed load clock signal is transited to the first level state after a first delay time after the load clock signal is transited from the second level state to the first level state. Further, it is configured that the delayed load clock signal is transited to the second level state after a second delay time after the load clock signal is transited from the first level state to the second level state, and the first delay time is longer than the second delay time.

According to a third aspect of the present invention, an image data acquisition method is provided for a display panel drive device. The display panel drive device is configured to capture each of pixel data pieces for one horizontal scan per each pixel at a timing different from each other according to a video signal, and to apply a drive pulse to each of a plurality of data lines of a display panel according to the pixel data pieces thus captured.

According to the third aspect of the present invention, the image data acquisition method includes the steps of setting a first delay time for shifting a start timing for capturing each of the pixel data pieces so that the start timings are shifted with each other; and setting a second delay time for shifting a complete timing for completing the capturing of each of the pixel data pieces so that the complete timings are shifted with each other. The first delay time and the second delay time are set so that the first delay time is longer than the second delay time.

In the present invention, a plurality of latch sections is provided for capturing each of the pixel data pieces for one horizontal scan per each pixel at the timing different from each other according to the video signal. Further, the drive pulse is applied to each of the data lines of the display panel according to the pixel data pieces thus captured. At this moment, the first delay time is set for shifting the start timing for capturing each of the pixel data pieces so that the start timings are shifted with each other; and the second delay time is set for shifting the complete timing for completing the capturing of each of the pixel data pieces so that the complete timings are shifted with each other. The first delay time and the second delay time are set so that the first delay time is longer than the second delay time.

Accordingly, even when the first delay time for shifting the start timing for capturing each of the pixel data pieces so that the start timings are shifted with each other is prolonged, it is possible to prevent a period of data acquisition time of each of the latch sections from being overlapped with a supply timing of the pixel data for a subsequent horizontal scan. Accordingly, it is possible to spread an electric current flowing into each of the data lines of the display panel with a sufficient delay time without causing an erroneous operation. As a result, it is possible to effectively reduce a noise.

### BRIEF DESCRIPTION OF THE DRAWINGS

FIG. 1 is a block diagram showing a configuration of a liquid crystal display device having a display panel drive device according to a first embodiment of the present invention;

FIG. 2 is a time chart showing an operation of a drive control unit and a data driver of the display panel drive device according to the first embodiment of the present invention;

FIG. 3 is a block diagram showing an internal configuration of the data driver of the display panel drive device according to the first embodiment of the present invention;

FIG. 4 is a circuit diagram showing a configuration of a shift register of the display panel drive device according to the first embodiment of the present invention;

FIG. 5 is a circuit diagram showing a configuration of a first latch portion of the display panel drive device according to the first embodiment of the present invention;

FIG. 6 is a circuit diagram showing a configuration of a second latch portion of the display panel drive device according to the first embodiment of the present invention;

FIG. 7 is a circuit diagram showing a configuration of a second latch portion of a display panel drive device according to a second embodiment of the present invention; and

FIG. 8 is a circuit diagram showing a configuration of a second latch portion of a display panel drive device according to a third embodiment of the present invention.

### DETAILED DESCRIPTION OF PREFERRED EMBODIMENTS

Hereunder, preferred embodiments of the present invention will be explained with reference to the accompanying drawings.

In a display panel drive device of the present invention, it is configured such that a latch portion of the display panel drive device is provided for capturing pixel data pieces for one horizontal scan per each pixel according to a video signal, so that the display panel drive device applies a drive pulse to each of a plurality of data lines of a display panel according to each of the pixel data pieces thus captured. The latch portion is configured to capture the pixel data pieces through the following process.

According to the present invention, the latch portion includes a first latch section and a second latch section configured to capture the pixel data pieces during a period of time when a clock signal supplied to a clock input terminal is in a first level state, and to retain the pixel data pieces captured when the clock signal is in the first level state when the clock signal is in a second level state. Further, a load clock signal is supplied to the clock input terminal of the first latch section, and a delayed load clock signal is supplied to the clock input terminal of the first latch section. The delayed load clock signal is obtained through delaying the load clock signal.

Further, according to the present invention, it is configured that the delayed load clock is transited to the first level state after a first delay time after the load clock signal is transited from the second level state to the first level state. Further, it is configured that the delayed load clock is transited to the second level state after a second delay time after the load clock signal is transited from the first level state to the second level state, and the first delay time is longer than the second delay time.

### First Embodiment

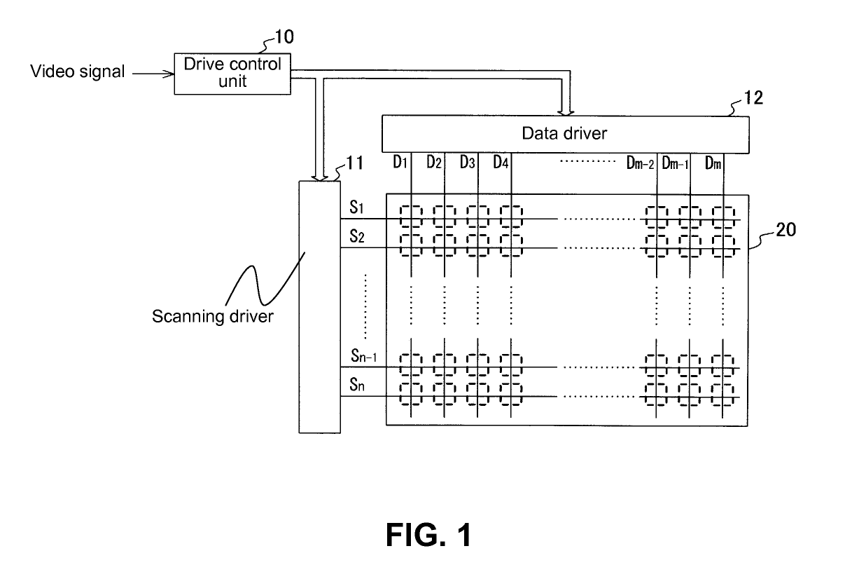

A first embodiment of the present invention will be explained. FIG. 1 is a block diagram showing a configuration of a liquid crystal display device having the display panel drive device according to the first embodiment of the present invention.

As shown in FIG. 1, the liquid crystal display device includes a display panel 20 as a liquid crystal panel. In order to drive a liquid crystal layer (not shown) of the display panel 20, each of scanning lines S1 to Sn in the number of n is extended in a horizontal direction of a two-dimensional screen of the display panel 20. Further, each of data lines D1 to Dm in the number of m is extended in a vertical direction of the two-dimensional screen of the display panel 20. Display cells corresponding to pixels are disposed in areas of crossing points between the scanning lines S1 to Sn and the scanning lines D1 to Dm.

In the embodiment, the display panel drive device includes a drive control unit 10 for generating a scanning control signal according to an input video signal, so that a scanning pulse is sequentially applied to each of the scanning lines S1 to Sn. Further, the display panel drive device includes a scanning driver 11 and a data driver 12. The drive control unit 10 is configured to supply the scanning control signal to the scanning driver 11.

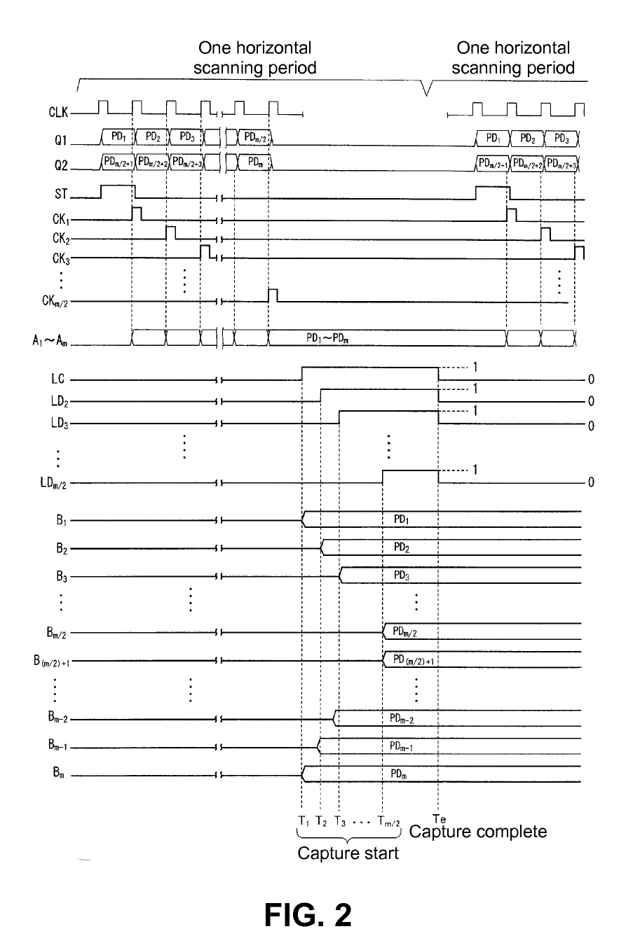

FIG. 2 is a time chart showing an operation of the drive control unit 10 and the data driver 12 of the display panel drive device according to the first embodiment of the present invention. As shown in FIG. 2, the drive control unit 10 is configured to generate a capture start pulse signal ST and a load clock signal LC synchronizing with a horizontal synchronization signal in the input video signal. Further, the drive control unit 10 is configured to supply a reference clock signal CLK to the data driver 12 along with the capture start pulse signal ST and the load clock signal LC.

In the embodiment, as shown in FIG. 2, the drive control unit 10 is configured to supply the capture start pulse signal ST for one pulse to the data driver 12 just one time at a front end portion per one horizontal scanning period. Further, the drive control unit 10 is configured to generate pixel data PD representing a brightness level of each pixel according to the input video signal. Further, the drive control unit 10 is configured to divide the pixel data PD in half per one horizontal scanning line, and to sequentially supply each of the halves to the data driver 12 at a timing synchronized with the reference clock signal CLK in a serial form.

More specifically, the drive control unit 10 is configured to divide the pixel data PD1 to PDm per one horizontal scanning line into a first pixel data series Q1 including the pixel data PD1 to PDm/2 and a second pixel data series Q2 including the pixel data PD(1+m/2) to PDm. Further, as shown in FIG. 2, the drive control unit 10 is configured to sequentially supply each of the pixel data PD1 to PDm in the first pixel data series Q1 and the second pixel data series Q2 to the data driver 12 synchronizing with the reference clock signal CLK.

In the embodiment, after the drive control unit 10 transmits all of the first pixel data series Q1 and the second pixel data series Q2 in a first half portion of the one horizontal scanning period, the drive control unit 10 supplies the load clock signal LC to the data driver 12 in a second half portion of the one horizontal scanning period. As shown in FIG. 2, the load clock signal LC has a pulse wave shape, in which a logic level is transited from “0” to “1”, and returned to “0”.

In the embodiment, the display panel drive device includes the scanning driver 11 for generating the scanning pulse according to the scanning control signal supplied from the drive control unit 10, and for sequentially and selectively applying the scanning pulse to each of the scanning lines S₁ to Sₙ of the display panel 20.

In the embodiment, the display panel drive device includes the scanning driver 11 for capturing the pixel data PD in the first pixel data series Q1 and the second pixel data series Q2 according to the various control signals (the capture start pulse signal ST, the delayed load clock signal LD, and the reference clock signal CLK) supplied from the drive control unit 10. Further, every time after the data driver 12 completely captures the pixel data PD₁ to PDₘ for one horizontal scanning line, the data driver 12 is configured to generate the drive pulse corresponding to each of the brightness levels indicated with each of the pixel data PD₁ to PDₘ, and to apply the drive pulse to each of the data lines D₁ to Dₘ of the display panel 20.

In the embodiment, it should be noted that each of the scanning driver 11 and the data driver 12 is disposed in one single semiconductor chip or a plurality of semiconductor chips.

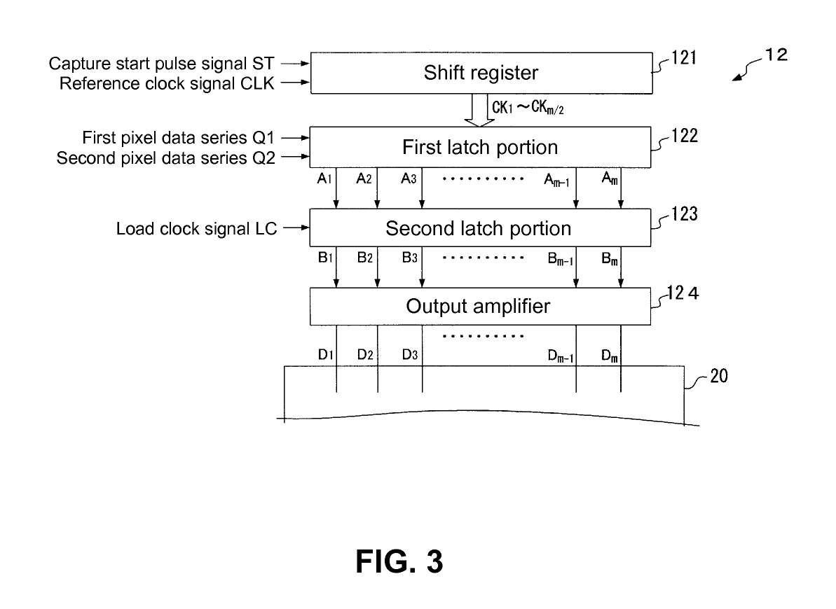

FIG. 3 is a block diagram showing an internal configuration of the data driver 12 of the display panel drive device according to the first embodiment of the present invention.

As shown in FIG. 3, the data driver 12 includes a shift register 121, a first latch portion 122, a second latch portion 123, and an output amplifier 124. As shown in FIG. 2, the shift register 121 is configured to sequentially generate the clock signals CK₁ to CKₘ per one horizontal scanning period according to the capture start pulse signal ST supplied from the drive control unit 10, so that the shift register 121 supplies the clock signals CK₁ to CKₘ to the first latch portion 122.

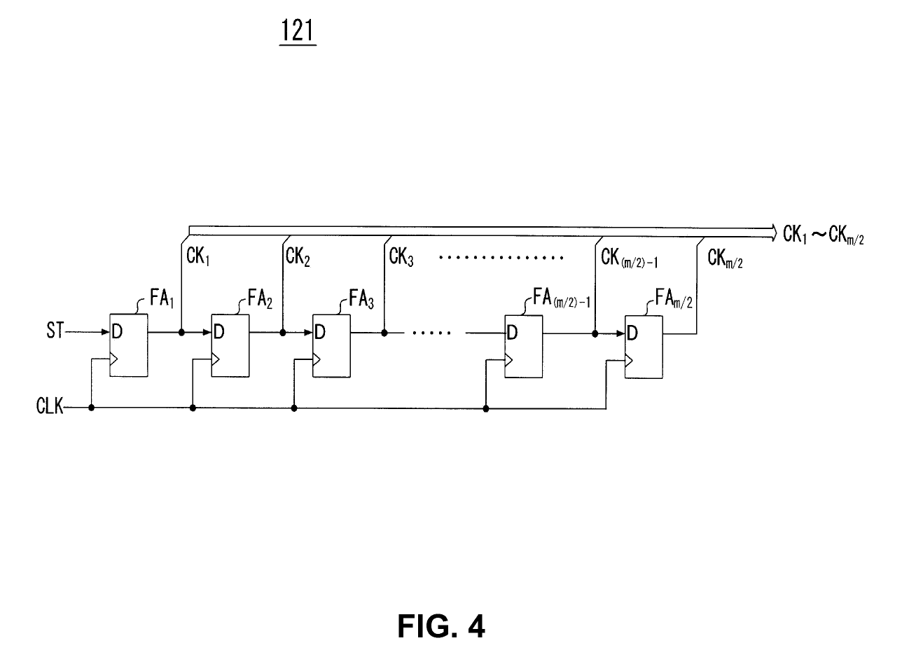

FIG. 4 is a circuit diagram showing a configuration of the shift register 121 of the display panel drive device according to the first embodiment of the present invention. As shown in FIG. 4, the shift register 121 includes D latches FA₁ to FA_{(m/2)} connected in series. As shown in FIG. 2, the shift register 121 is configured to sequentially shift the capture start pulse signal ST to one of the D latches DA at the next stage according to the reference clock signal CLK. At this moment, as shown in FIG. 2, an output of each of the D latches FA₁ to FA_{(m/2)} is supplied to the shift register 121 as the clock signals CK₁ to CK_{(m/2)}.

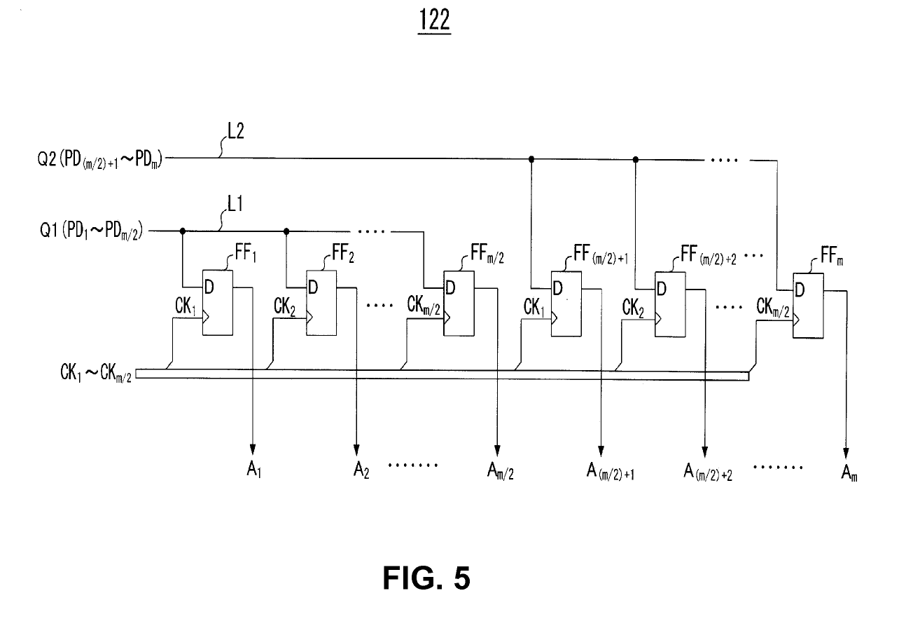

FIG. 5 is a circuit diagram showing a configuration of the first latch portion 122 of the display panel drive device according to the first embodiment of the present invention. As shown in FIG. 5, the first latch portion 122 includes D latches FF₁ to FFₘ connected in series. As shown in FIG. 2, the first pixel data series Q1 (the pixel data PD₁ to PD_{m/2}) is commonly supplied through a data line L1 to each of data input terminals D of the D latches FF₁ to FF_{(m/2)} among the D latches FF₁ to FFₘ. Each of the clock signals CK₁ to CK_{(m/2)} supplied from the shift register 121 is separately supplied to each of the clock input terminals of the D latches FF₁ to FF_{(m/2)}.

Through the process described above, each of the D latches FF₁ to FF_{(m/2)} captures the first pixel data series Q1 at the timing of the clock signals CK₁ to CK_{(m/2)} supplied to each of the D latches FF₁ to FF_{(m/2)}. Further, each of the D latches FF₁ to FF_{(m/2)} supplies the value of the pixel data thus captured as the pixel data A₁ to A_{(m/2)} to the second latch portion 123.

More specifically, for example, the D latch FF₁ captures the pixel data PD₁ in the first pixel data series Q1 at the timing of the clock signal CK₁ as shown in FIG. 2. Further, the D latch FF₁ supplies the pixel data PD₁ as the pixel data A₁ to the second latch portion 123. Similarly, the D latch FF₂ captures the pixel data PD₂ in the first pixel data series Q1 at the timing of the clock signal CK₂ as shown in FIG. 2. Further, the D latch FF₂ supplies the pixel data PD₂ as the pixel data A₂ to the second latch portion 123. Similarly, the D latch FF_{m/2} captures the pixel data PD_{m/2} in the first pixel data series Q1 at the timing of the clock signal CK_{m/2} as shown in FIG. 2. Further, the D latch FF_{m/2} supplies the pixel data PD_{m/2} as the pixel data A_{m/2} to the second latch portion 123.

As shown in FIG. 5, the first latch portion 122 includes D latches FF_{(m/2)+1} to FFₘ connected in series. As shown in FIG. 2, the second pixel data series Q2 (the pixel data PD_{(m/2)+1} to PDₘ) is commonly supplied through a data line L2 to each of data input terminals D of the D latches FF_{(m/2)+1} to FFₘ among the D latches FF₁ to FFₘ. Each of the clock signals CK₁ to CK_{(m/2)} supplied from the shift register 121 is separately supplied to each of the clock input terminals of the D latches FF_{(m/2)+1} to FFₘ.

Through the process described above, each of the D latches FF_{(m/2)+1} to FFₘ captures the second pixel data series Q2 at the timing of the clock signals CK₁ to CK_{(m/2)} supplied to each of the D latches FF_{(m/2)+1} to FFₘ. Further, each of the D latches FF_{(m/2)+1} to FFₘ supplies the value of the pixel data thus captured as the pixel data A_{(m/2)+1} to Aₘ to the second latch portion 123.

More specifically, for example, the D latch FF_{(m/2)+1} captures the pixel data PD_{(m/2)+1} in the second pixel data series Q2 at the timing of the clock signal CK_{(m/2)+1} as shown in FIG. 2. Further, the D latch FF_{(m/2)+1} supplies the pixel data PD_{(m/2)+1} as the pixel data A_{(m/2)+1} to the second latch portion 123. Similarly, the D latch FF_{(m/2)+2} captures the pixel data PD_{(m/2)+2} in the second pixel data series Q2 at the timing of the clock signal CK_{(m/2)+2} as shown in FIG. 2. Further, the D latch FF_{(m/2)+2} supplies the pixel data PD_{(m/2)+2} as the pixel data A_{(m/2)+2} to the second latch portion 123. Similarly, the D latch FFₘ captures the pixel data PDₘ in the second pixel data series Q2 at the timing of the clock signal CKₘ as shown in FIG. 2. Further, the D latch FFₘ supplies the pixel data PDₘ as the pixel data Aₘ to the second latch portion 123.

With the configuration described above, the first latch portion 122 sequentially captures each of the pixel data PD₁ to PDₘ for one horizontal scanning line supplied from the drive control unit 10 in series into the D latches FF₁ to FFₘ in the number of m. Then, the first latch portion 122 supplies the pixel data PD₁ to PDₘ as the pixel data A₁ to Aₘ to the first latch portion 122 at the later stage.

In the embodiment, the second latch portion 123 is configured to capture each of the pixel data A₁ to Aₘ according to lc as shown in FIG. 2. Afterward, the second latch portion 123 is configured to supply each of the pixel data A₁ to Aₘ as the pixel data B₁ to Bₘ to the output amplifier 124.

In the embodiment, the output amplifier 124 is configured to generate the drive pulse having a voltage corresponding to the brightness level of each of the pixel data B₁ to Bₘ. Afterward, the output amplifier 124 is configured to supply the drive pulse to the data lines D₁ to Dₘ of the display panel 20. It is noted that the output amplifier 124 is configured such that the capture timing of each of the D latches is shifted. Accordingly, the peak currents flowing into the data lines D₁ to Dₘ of the display panel 20 are spread with respect to a period of time.

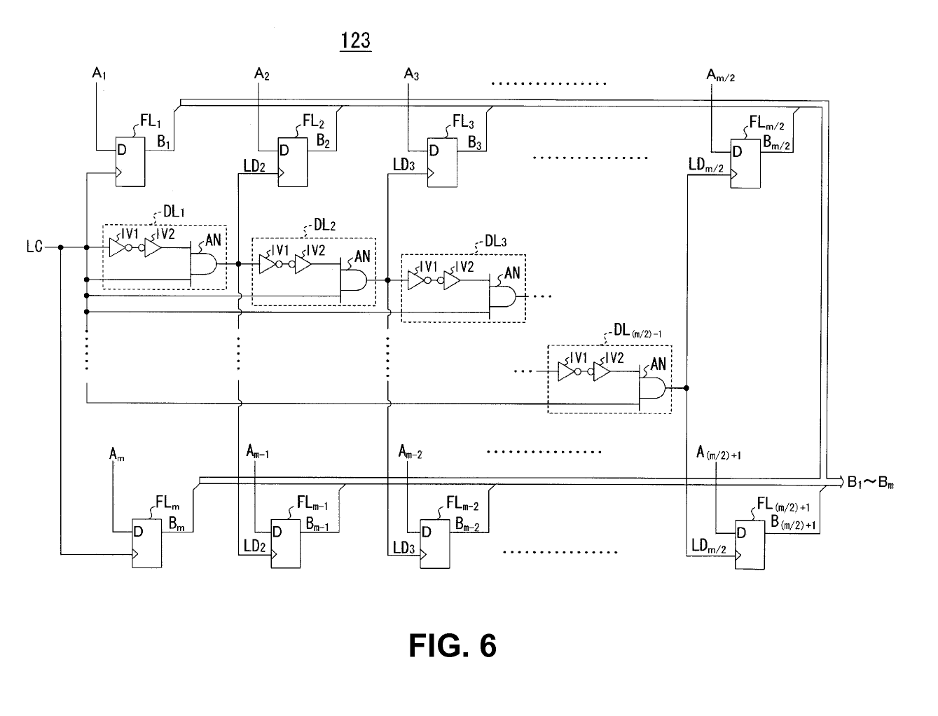

FIG. 6 is a circuit diagram showing a configuration of the second latch portion 123 of the display panel drive device according to the first embodiment of the present invention.

As shown in FIG. 6, the second latch portion 123 includes D latches FL₁ to FLₘ of a level sensitive type. Each of the D latches FL₁ to FLₘ is configured to capture the pixel data A₁ to Aₘ supplied from the first latch portion 122 only during a period of time when the clock signal supplied to a clock input terminal of each of the D latches FL₁ to FLₘ is in the state of the logic level “1”. Afterward, each of the D latches FL₁ to FLₘ is configured to supply the pixel data A₁ to Aₘ to the output amplifier 124 as the pixel data B₁ to Bₘ.

In the embodiment, when the clock signal supplied to the clock input terminal of each of the D latches FL₁ to FLₘ is in the state of the logic level “0”, each of the D latches FL₁ to FLₘ is configured to retain the pixel data A₁ to Aₘ captured during a period of time when the clock signal is in the state of the logic level “1”. Afterward, each of the D latches FL₁ to FLₘ is configured to supply the pixel data A₁ to Aₘ to the output amplifier 124 as the pixel data B₁ to Bₘ.

More specifically, as shown in FIG. 2, the load clock signal LC is supplied as the clock signal to the clock input terminal of each of the D latch FL₁ at the first location and the D latch FL_{(m/2)+1} at the (m/2)+1th location among the D latches FL₁ to FLₘ. Further, as described later, each of delayed load clock signals LD₂ to LD_{m/2} is supplied to the clock input terminal of each of the D latches FL₂ to FL_{m/2} at the second to the m/2th locations and the D latches FL₍ₘ₋₁₎ to _{FL(m/2)+2} at the m−1th to the m/2+2th locations.

As shown in FIG. 6, the second latch portion 123 further includes delay circuits DL₁ to DL₍ₘ₄₂₎₋₁. For example, the delay circuit DL₁ is configured to supply the delayed load clock signal LD₂ obtained through delaying the load clock signal LC by a specific period of time as the clock signal to the clock input terminal of each of the D latches FL₂ and FLₘ₋₁. Further, the delay circuit DL₂ is configured to supply the delayed load clock signal LD₃ obtained through delaying the delayed load clock signal LD₂ by a specific period of time as the clock signal to the clock input terminal of each of the D latches FL₃ and FLₘ₋₂.

In the embodiment, the delay circuit DL₃ is configured to supply the delayed load clock signal LD₄ obtained through delaying the delayed load clock signal LD₃ by a specific period of time as the clock signal to the clock input terminal of each of the D latches FL₄ and FLₘ₋₃. Further, the delay circuit DL_{(m/2)-1} is configured to supply the delayed load clock signal LD_{m/2} obtained through delaying the delayed load clock signal LD_{(m/2)-1} by a specific period of time as the clock signal to the clock input terminal of each of the D latches FL_{m/2} and FL_{(m/2)+1}.

As described above, in the embodiment, the delay circuit DLₖ (k is 1 to (m/2)−1) is configured to supply the delayed load clock signal LDₖ₊₁ obtained through delaying the delayed load clock signal LDₖ supplied to the clock input terminal of the D latch FLₖ at the kth location by a specific period of time as the clock signal to the clock input terminal of each of the D latches FLₖ₊₁ and FLₘ₋₍ₖ₋₁₎.

In the embodiment, as shown in FIG. 6, each of delay circuits DL₁ to DL_{(m/2)-1} is formed of inverters IV1 and IV2 connected to each other in series and an and gate AN. The inverter IV1 of the delay circuit DL₁ is provided for supplying an inverted clock signal having an inverted logic level of that of the load clock signal LC to the inverter IV2. The inverter IV2 of the delay circuit DL₁ is provided for supplying a signal having an inverted logic level of that of the inverted clock signal to the and gate AN. As a result, the inverters IV1 and IV2 delays the load clock signal LC to generate the delayed clock signal, so that the delayed clock signal is supplied to the and gate AN.

In the embodiment, the and gate AN of the delay circuit DL₁ is provided for obtaining a logic product of the load clock signal LC and the delayed clock signal obtained with the inverters IV1 and IV2 through delaying the load clock signal LC. Accordingly, the and gate AN of the delay circuit DL₁ generates the logic product as the delayed load clock signal LD₂.

Similarly, the inverter IV1 of each of the delay circuits DL₂ to DL_{(m/2)-1} is provided for supplying an inverted clock signal having an inverted logic level of that of the delayed load clock signal LDₖ (k is 2 to (m/2)-1) to the inverter IV2. The inverter IV2 of each of the delay circuits DL₂ to DL_{(m/2)-1} is provided for supplying a signal having an inverted logic level of that of the inverted clock signal to the and gate AN. Further, the and gate AN of each of the delay circuits DL₂ to DL_{(m/2)-1} is provided for obtaining a logic product of the delayed load clock signal LDₖ and the delayed clock signal obtained with the inverters IV1 and IV2 through delaying the delayed load clock signal LDₖ. Accordingly, the and gate AN of the delay circuit DL₁ generates the logic product as the delayed load clock signal LDₖ₊₁.

In the embodiment, as shown in FIG. 6, each of the delay circuits DL₁ to DL_{(m/2)-1} is the delay circuit utilizing the delay time consumed during the process of the delay element formed of the inverters IV1 and IV2 and the and gate AN. The delay element is formed of the inverters IV1 and IV2 connected in series in the two-stage configuration. It is noted that the present invention is not limited to the two-stage configuration connected in series. Further, the delay element may be formed of a logic element other than the inverter.

With the configuration described above, the delayed load clock signals LD₂ to DL_{m/2} are obtained through delaying the load clock signal LC with different delay amounts. Afterward, the delayed load clock signals LD₂ to DL_{m/2} are supplied to the clock input terminals of the D latches FL₂ to FL_{m/2} and the D latches FL_{(m/2)-1} to FLₘ.

Accordingly, in the embodiment, with respect to the rising edge of the load clock signal LC, at which the load clock signal LC is switched from the state of the logic level “0” to the state of the logic level “1”, each of the delayed load clock signals LD₂ to DL_{m/2} has the rising edge at the timing as shown in FIG. 2.

For example, as shown in FIG. 2, with respect to the timing T₂ of the rising edge of the load clock signal LC, the rising edge of the delayed load clock signals LD₂ appears at the timing T₂ elapsed by the delay time due to the delay circuit DL_{I}. Further, with respect to the timing T₂ of the rising edge of the load clock signal LC, the rising edge of the delayed load clock signals LD₃ appears at the timing T₃ elapsed by the delay time due to the delay circuit DL₁ and the delay circuit DL₂.

Accordingly, the D latches FL₂ to FLₘ of the second latch portion 123 are configured to capture the pixel data A₁ to Aₘ supplied from the first latch portion 122 at the different timings. Afterward, as shown in FIG. 2, the D latches FL₂ to FLₘ of the second latch portion 123 are configured to supply the pixel data A₁ to Aₘ as the pixel data B₁ to Bₘ at the different timings to the output amplifier 124.

As described above, when the D latches FL₂ to FLₘ of the second latch portion 123 capture the pixel data A₁ to Aₘ, the value of the pixel data retained in each of the D latches FL₂ to FLₘ of the second latch portion 123 may be transited from the low level state to the high level state (or vice versa). In the embodiment, as shown in FIG. 2, the D latches FL₂ to FLₘ of the second latch portion 123 are configured to supply the pixel data A₁ to Aₘ as the pixel data B₁ to Bₘ at the different timings to the output amplifier 124.

Accordingly, when the drive pulse corresponding to each of the pixel data B₁ to Bₘ is applied to each of the data lines D₂ to Dₘ of the display panel 20, it is possible to minimize the total current amount flowing into the data lines D₂ to Dₘ. As a result, it is possible to reduce the noise associated with the concurrent flow of the current into the data lines D₂ to Dₘ.

In the embodiment, it is noted that the delay circuit DLₖ of the second latch portion 123 shown in FIG. 6 is configured to generate the logic product result of the load clock signal LC and the delayed load clock signal LDₖ as the delayed load clock signal LDₖ₊₁.

Accordingly, in the embodiment, each of the load clock signal LC and the delayed load clock signals LD₂ to LD_{m/2} have the rising edge, or the data capture start timing of each of the D latches FL, at the different timings. Further, as shown in FIG. 2, the timings of the declining edges, at which the load clock signal LC and the delayed load clock signals LD₂ to LD_{m/2} are transited from the state of the logic level “1” to the state of the logic level “0”, or the data capture completion timing of each of the D latches FL, are the same as at the timing Te. In other words, the delayed load clock signals LD₂ to LD_{m/2} have only the timings of the rising edges thereof delayed relative to the load clock signal LC.

Accordingly, in the embodiment, as shown in FIG. 2, at the timing Te when the load clock signal LC is transited from the state of the logic level “1” to the state of the logic level “0”, the delayed load clock signals LD₂ to LD_{m/2}, which are supplied to the clock input terminal of not only the D latch FL₁ and the D latch FLₘ but also all other D latches FL, are also transited from the state of the logic level “1” to the state of the logic level “0”. As a result, even when the delay time or the delay stage number of the delay circuit DL is increased relative to the load clock signal LC, it is possible to prevent the data capture period of the D latches FL₁ to FLₘ of the second latch portion 123 from being overlapped with the capture timing of the pixel data of the subsequent one horizontal scanning with the first latch portion 122.

Accordingly, in the embodiment, with the second latch portion 123 shown in FIG. 6, it is possible to spread the electric current flowing into each of the data lines D₁ to Dₘ of the display panel 20 over a period of time with the sufficient delay time. As a result, it is possible to effectively reduce a noise.

### Second Embodiment

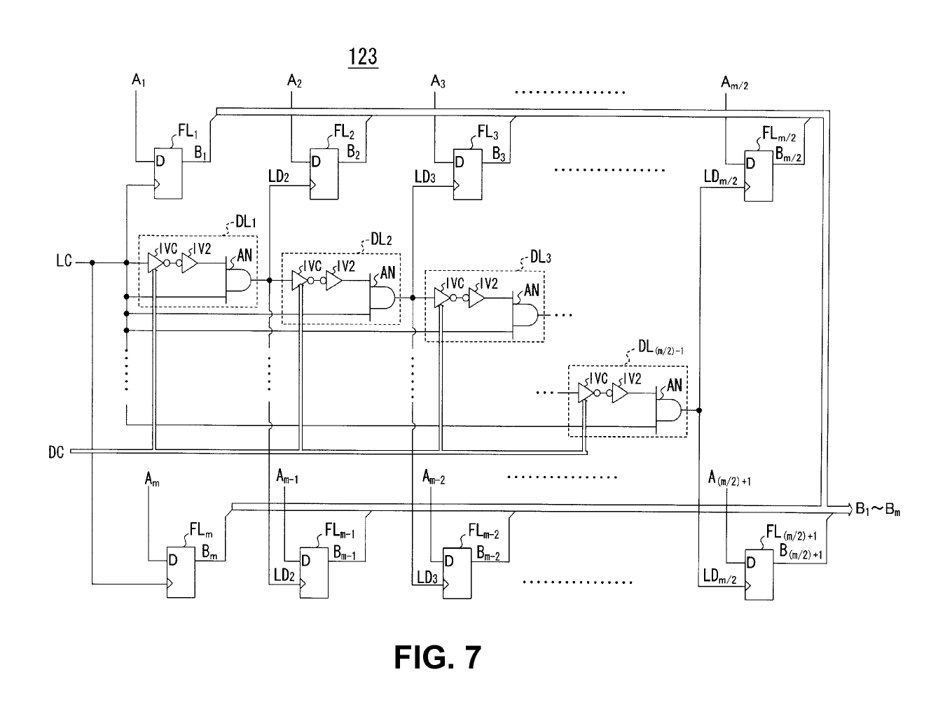

A second embodiment of the present invention will be explained next with reference to FIG. 7. FIG. 7 is a circuit diagram showing a configuration of the second latch portion 123 of the display panel drive device according to the second embodiment of the present invention.

In the second embodiment, as shown in FIG. 7, each of the delay circuits DL₁ to DL_{(m/2)-1} includes a variable delay element IVC having a logic conversion function, instead of the inverter IV1. Other configuration and the operation thereof are similar to those in the first embodiment shown in FIG. 6.

In the second embodiment, when the second latch portion 123 has the configuration shown in FIG. 7, the drive control unit 10 is configured to receive an external input for specifying individually the delay amount for each of the delay circuits DL₁ to DL_{(m/2)-1}. Further, the drive control unit 10 is configured to supply delay amount specifying data DC indicating the delay amount for each of the delay circuits DL₁ to DL (m/2)-1 to each of the delay circuits DL₁ to DL_{(m/2)-1}.

In the second embodiment, the variable delay element IVC of each of the delay circuits DL₁ to DL_{(m/2)-1} is configured to delay the load clock signal LC or the delayed load clock signal LD supplied from the front stage with the delay amount specified with the delay amount specifying data DC supplied from the drive control unit 10. Further, the variable delay element IVC of each of the delay circuits DL₁ to DL_{(m/2)-1} is configured to supply a signal with an inverted logic level to the inverter IV2 thereof.

Accordingly, in the second latch portion 123 shown in FIG. 7, it is possible to arbitrarily adjust the data capture start timing of each of the D latches FL₂ to FL_{m/2} and the D latches FL_{(m/2)+2} to FLₘ.

In the second embodiment, the second latch portion 123 includes the D latches FL₁ to FLₘ, and the pixel data PD is captured during a period of time only when the clock signal supplied to the clock input terminal has the logic level “1”. Alternatively, it may be configured such that the pixel data PD is captured during a period of time only when the clock signal supplied to the clock input terminal has the logic level “0”. In other word, it is suffice that the D latches FL₁ to FLₘ are configured to be the level sensitive type D latches such that the pixel data PD is captured during a period of time only when the clock signal supplied to the clock input terminal has the first level state or the second level state.

In the second embodiment, similar to the configuration shown in FIG. 6, the second latch portion 123 shown in FIG. 7 includes the and gate AN in each of the delay circuits DL₁ to DL_{(m/2)-1}. Accordingly, as shown in FIG. 2, each of the D latches FL₁ to FLₘ has the different data capture start timing (one of T₁ to T_{m/2}) and the same data capture completion timing (Te). Alternatively, the D latches FL₁ to FLₘ may be configured such that the data capture completion timings thereof relative to the load clock signal LC are not coincident.

In other words, it is suffice that the data capture completion timings of the D latches FL₁ to FLₘ be different by the delay amount smaller than the delay amount for shifting the data capture start timings of the D latches FL₁ to FLₘ. More specifically, the delay circuits DL₁ to DL_{(m/2)-1} are configured such that the delay time from when the load clock signal LC is transited from the logic level “0” to the logic level “1” to when the delayed load clock signal LD is transited to the logic level “1” becomes shorter than the delay time from when the load clock signal LC is transited from the logic level “1” to the logic level “0” to when the delayed load clock signal LD is transited to the logic level “0”.

In the second embodiment, the data lines D₂ to Dₘ of the display panel 20 are divided into the two groups. Further, it is configured such that the drive pulse is applied to each of the data lines D of each group in the number of m/2 at the different timing. Alternatively, it may be configured such that the drive pulse is applied to each of all of the data lines D₂ to Dₘ of the display panel 20 at the different timing.

Further, in the second embodiment, the data driver 12 includes the four modules such as the shift register 121, the first latch portion 122, the second latch portion 123, and the output amplifier 124, and the data driver 12 is formed of one single semiconductor chip or a plurality of semiconductor chips. Alternatively, each of the modules may be formed of a semiconductor chip. Alternatively, two or three of the four modules may be integrated and formed of a semiconductor chip.

Further, in the second embodiment, in the second latch portion 123 shown in FIG. 6, the delay circuits DL₂ to DL_{(m/2)-1} are configured to output the delayed load clock signals LD₂ to LD_{m/2}. Further, the group of the D latches FL₂ to FL_{m/2} and the group of the D latches FL_{(m/2)+2} to FLₘ shear the delayed load clock signals LD₂ to LD_{m/2}. Alternatively, the delay circuits DL₂ to DL_{(m/2)—2} may be disposed per each of the groups of the D latches FL₂ to FLₘ.

### Third Embodiment

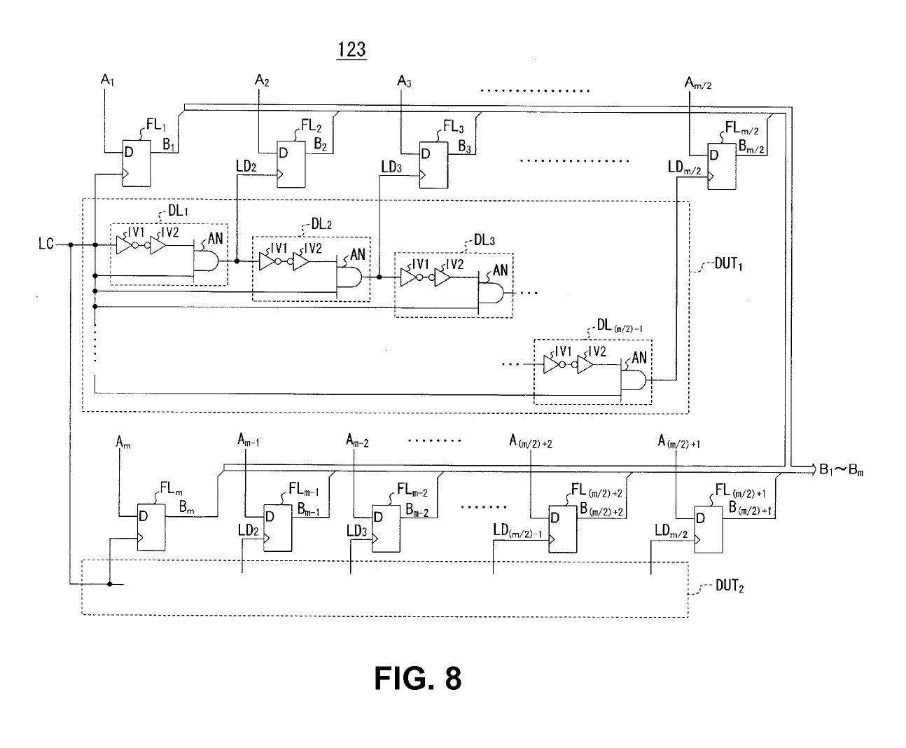

A third embodiment of the present invention will be explained next with reference to FIG. 8. FIG. 8 is a circuit diagram showing a configuration of the second latch portion 123 of the display panel drive device according to the third embodiment of the present invention.

In the third embodiment, the operation of the D latches FL₁ to FLₘ, the operation of the delay circuits DL₁ to DL_{(m/2)-1} and the operation of the second latch portion 123 are similar to those in the first embodiment shown in FIG. 6.

In the third embodiment, the second latch portion 123 includes a first delay circuit group DUT₁ and a second delay circuit group DUT₂, and the load clock signal LC is directly supplied to the clock input terminal of each of the D latches FL₁ and FLₘ. Further, the delayed load clock signals LD₂ to LD_{m/2} transmitted from the first delay circuit group DUT₁ formed of the delay circuits DL₁ to DL_{(m/2)-1} are supplied to the clock input terminals of the D latches FL₁ to FLₘ, respectively. Further, similar to the first delay circuit group DUT₁, the delayed load clock signals LD₂ to LD_{m/2} transmitted from the second delay circuit group DUT₂ formed of the delay circuits DL₁ to DL_{(m/2)-1} are supplied to the clock input terminals of the D latches FLₘ₋₁ to FL_{(m/2)-1}, respectively.

In the third embodiment, as shown in FIG. 8, the delay circuits DL₁ to DL_{(m/2)-1} are provided as the two groups (the first delay circuit group DUT₁ and the second delay circuit group DUT₂). However, only one wiring portion needs to be disposed for connecting between the latch group of the D latches FL₁ to FL_{m/2} and the latch group of the D latches FL_{(m/2)+1} to FLₘ for transmitting the load clock signal LC. On the other hand, in the configuration shown in FIG. 6, it is necessary to provide wiring portions in the number of (m/2)−1 for transmitting the delayed load clock signals LD₂ to LD_{m/2} between the latch groups. Accordingly, in the third embodiment, it is possible to reduce a chip occupied area.

The disclosure of Japanese Patent Application No. 2011-0065241, filed on Mar. 24, 2011, is incorporated in the application by reference.

While the invention has been explained with reference to the specific embodiments of the invention, the explanation is illustrative and the invention is limited only by the appended claims.

What is claimed is:

1. A display panel drive device for applying a drive pulse to each of a plurality of data lines formed in a display panel according to a video signal, comprising:
a latch portion for capturing each of pixel data pieces for one horizontal scan per each pixel at a timing different from each other according to the video signal, and for outputting each of the pixel data pieces as a captured pixel data piece; and
an output amplifier for applying the drive pulse corresponding to a brightness level indicated with each of the captured pixel data pieces to each of the data lines of the display panel,
wherein said latch portion includes a first latch section, a delay circuit, and a second latch section;
said first latch section is configured to capture the pixel data pieces when a load clock signal is in a first level state;
said first latch section is configured to retain the pixel data pieces captured when the load clock signal is in the first level state when the load clock signal is in a second level state;
said delay circuit is configured to generate a delayed load clock signal through delaying the load clock signal;
said second latch section is configured to capture the pixel data pieces when the delayed load clock signal is in a first level state;
said second latch section is configured to retain the pixel data pieces captured when the delayed load clock signal is in the first level state when the delayed load clock signal is in a second level state;
said latch portion is configured so that the delayed load clock signal is transited to the first level state after a first delay time after the load clock signal is transited from the second level state to the first level state; and
said latch portion is configured so that the delayed load clock signal is transited to the second level state after a second delay time after the load clock signal is transited from the first level state to the second level state, said first delay time being longer than the second delay time.

2. The display panel drive device according to claim 1, wherein said latch portion is configured so that the delayed load clock signal is transited from the first level state to the second level state after at the same time when the load clock signal is transited from the first level state to the second level state.

3. The display panel drive device according to claim 1, wherein said delay circuit is configured to generate the delayed load clock signal through delaying the load clock signal by the first delay time or the second delay time according to a delay amount input externally.

4. The display panel drive device according to claim 1, wherein said delay circuit includes a delay element for generating the delayed load clock signal through delaying the load clock signal and an and gate for generating a logic sum of the delayed load clock signal and the load clock signal as the delayed load clock signal.

5. The display panel drive device according to claim 4, wherein said delay element is configured to generate the delayed load clock signal through delaying the load clock signal by the first delay time or the second delay time according to a delay amount input externally.

6. A semiconductor integrated device for generating a drive pulse to be applied to each of a plurality of data lines formed in a display panel according to a video signal, comprising:
a latch portion for capturing each of pixel data pieces for one horizontal scan per each pixel at a timing different from each other according to the video signal, and for outputting each of the pixel data pieces as a captured pixel data piece; and
an output amplifier for applying the drive pulse corresponding to a brightness level indicated with each of the captured pixel data pieces to each of the data lines of the display panel,
wherein said latch portion includes a first latch section, a delay circuit, and a second latch section;
said first latch section is configured to capture the pixel data pieces when a load clock signal is in a first level state;
said first latch section is configured to retain the pixel data pieces captured when the load clock signal is in the first level state when the load clock signal is in a second level state;
said delay circuit is configured to generate a delayed load clock signal through delaying the load clock signal;
said second latch section is configured to capture the pixel data pieces when the delayed load clock signal is in a first level state;
said second latch section is configured to retain the pixel data pieces captured when the delayed load clock signal is in the first level state when the delayed load clock signal is in a second level state;
said latch portion is configured so that the delayed load clock signal is transited to the first level state after a first delay time after the load clock signal is transited from the second level state to the first level state; and
said latch portion is configured so that the delayed load clock signal is transited to the second level state after a second delay time after the load clock signal is transited from the first level state to the second level state, said first delay time being longer than the second delay time.

7. The semiconductor integrated device according to claim 6, wherein said latch portion is configured so that the delayed load clock signal is transited from the first level state to the second level state after at the same time when the load clock signal is transited from the first level state to the second level state.

8. The semiconductor integrated device according to claim 6, wherein said delay circuit is configured to generate the delayed load clock signal through delaying the load clock signal by the first delay time or the second delay time according to a delay amount input externally.

9. The semiconductor integrated device according to claim 6, wherein said delay circuit includes a delay element for generating the delayed load clock signal through delaying the load clock signal and an and gate for generating a logic sum of the delayed load clock signal and the load clock signal as the delayed load clock signal.

10. The semiconductor integrated device according to claim 9, wherein said delay element is configured to generate the delayed load clock signal through delaying the load clock signal by the first delay time or the second delay time according to a delay amount input externally.

11. An image data acquisition method in a display panel drive device for applying a drive pulse to each of a plurality of data lines of a display panel, comprising the steps of:
capturing each of pixel data pieces for one horizontal scan per each pixel at a timing different from each other according to a video signal;
setting a first delay time for shifting a start timing for capturing each of the pixel data pieces so that the start timings are shifted with each other; and
setting a second delay time for adjusting a complete timing for completing the capturing of each of the pixel data pieces.

12. The image data acquisition method in the display panel drive device according to claim 11, wherein said second delay time is set so that the complete timings are matched with each other.

13. The image data acquisition method in the display panel drive device according to claim 11, wherein said second delay time is set so that the complete timings are shifted with each other, said second delay time being set so that the first delay time is longer than the second delay time.
